(19) United States
(12) Patent Application Publication
(10) Pub. No.: US 2004/0155202 A1
(43) Pub. Date: Aug. 12, 2004

(54) Methods and apparatus for molecular species detection, inspection and classification using ultraviolet fluorescence

(75) Inventors: Wade Martin Poteet, Tucson, AZ (US); Harold K. Cauthen, Sonoita, AZ (US); Timothy D. Shriver, Vail, AZ (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: CDEX, INC.

(21) Appl. No.: 10/717,921

(22) Filed: Nov. 21, 2003

Related U.S. Application Data
(60) Provisional application No. 60/427,935, filed on Nov. 21, 2002.

(51) Int. Cl. G01N 21/64

(52) U.S. Cl. 250/461.1; 702/28

(57) ABSTRACT

The invention provides a system and method utilizing fluorescence spectroscopy in the ultraviolet portion of the electromagnetic spectrum to determine species and concentration of gases, solids and liquids from a substantial standoff distance. Target materials under investigation may include explosives, drugs, bio-aerosols, and controlled substances such as narcotics. The basic measuring system comprises optics, a spectrograph, a detector, and an energy source (“head” components), along with a computer and control electronics and power source.

### CROSS REFERENCE TO RELATED APPLICATIONS

This application claims priority under 35 U.S.C. § 119(e) to U.S. Provisional Patent Application No. 60/427,935 filed on Nov. 21, 2002, the disclosure of which is incorporated by reference in its entirety herein.

### BACKGROUND OF THE INVENTION

1. Field of the Invention

The invention relates generally to the field of substance and material detection, inspection, and classification. In particular, a fluorescence detection system with a high degree of specificity and accuracy, operating in the ultraviolet portion of the electromagnetic spectrum and capable of use at large stand-off distances, is utilized to identify specific individual and unique mixtures of substances.

2. Discussion of the Related Art

Ultraviolet (“UV”) fluorescence spectroscopy is an analytical technique used to identify and characterize chemical and biological materials and compositions. In operation, UV fluorescence systems direct energy (in the form of concentrated photons) from an excitation source toward a target area using, for example, reflective and/or refractive optics. Photoelectric interactions of the photons with the sample material produce detectable wavelength-shifted emissions that are typically at longer wavelengths (toward the visible) than the absorbed excitation ultraviolet photons.

The wavelength shift is due to an energy transfer from the incident photons (at an appropriate wavelength) to the target materials. The transferred energy causes some of the sample's electrons to either break free or enter an excited (i.e. higher) energy state. Thus, these excited electrons occupy unique energy environments that differ for each particular molecular species being examined. As a result, electrons from higher energy orbital states “drop down” and fill orbitals vacated by the excited electrons. The energy lost by the electrons going from higher energy states to lower energy states results in an emission spectra unique to each substance. When this process occurs in a short time, usually 100 nanoseconds or less, the resultant photon flux is referred to as fluorescence.

The resultant emission spectrum generated is detected with an ultraviolet spectrograph, digitized and analyzed (i.e. wavelength discrimination). Each different substance within the target area produces a unique spectrum that can be sorted and stored for comparison during subsequent analyses of known or unknown materials.

UV fluorescence spectroscopy does have some drawbacks. First, it can be affected by interference (or clutter). Interference is defined as unwanted UV flux reaching the detector that does not contribute directly to the identification of a material of interest. For example, when attempting to detect illegal substance on clothing, clutter can arise from exciting unimportant molecules in the target area, exciting materials close to the detector/emitter region, external flux from outside the target area (including external light sources) and scattering from air and/or dust in the light path. Thus, one goal of the invention is enabling efficient and accurate discrimination between all these and other sources of interference in conjunction with an appropriate analysis system (using specific algorithms and spectral filtering).

UV fluorescence systems are also limited in terms of sensitivity distances. Greater distances between the substance of interest and the UV excitation source and detector result in weaker return photon flux (i.e. weaker, if any, fluorescence) from the sample material. The present invention accounts for weakening of the signal through a synchronous source/detector system and selection of the spectral range optimized for the particular substance of interest. Factors influencing the range and sensitivity include integration time, receiving optics aperture, source power and the characteristics of the path through which the ultraviolet light travels.

Conventional spectroscopy and detection techniques include, among other things, neutron activation analysis, ultraviolet absorption, ion mobility spectroscopy, scattering analysis, nuclear resonance fluorescence, quadrupole resonance and various chemical sensors. Each of these methodologies, however, suffers from deficiencies. For example, neutron activation analyses, while capable of directly measuring ratios of atomic constituents (e.g., hydrogen, oxygen, nitrogen, and carbon) require large energy source (such as accelerators) that have high power demands. Traditional UV absorption and scattering techniques are subject to high degrees of inaccuracy (i.e. false alarms and omissions) absent sizeable reference resources and effective predictive analysis system. Scattering analysis techniques suffer similar shortcomings.

Ion mobility spectroscopy devices are currently in use at many airports for “wiping” analysis, but suffer from low sensitivities and have high maintenance demands. Resonance fluorescence is an emerging and promising technology, but requires a large, complex energy source for operation. Quadrupole resonance techniques offer a good balance of portability and accuracy, but are only effective for a limited number of materials (i.e. they have an extremely small range of materials they can reliably and accurately detect). Finally, chemical sensors, while very accurate, are slow acting and have limited ranges. Furthermore, chemical sensors do not always produce consistent results under varying environmental conditions (e.g. high humidity and modest air currents).

### SUMMARY OF THE INVENTION

The invention relates to a system and methods for material detection, inspection, and classification. In particular, a fluorescence detection system with a high degree of specificity and accuracy, operating in the ultraviolet portion of the electromagnetic spectrum and capable of use at large stand-off distances, is utilized to identify specific individual and unique mixtures of substances (including remote, real-time concentration measurements of individual chemical species in complex mixtures).

In general, the invention utilizes an ultraviolet source to generate fluorescence within a target area. Once excited, electron decay within the target substance causes detectable emission at UV wavelengths that can be uniquely matched to known materials. Thus, the system can provide a “fingerprint” identification of target materials. The system is non-penetrating and primarily only detects surface borne materials (except where a UV transparent material is being examined). The invention also includes a database of known signature spectra, as detected by the invention, for certain agents and substances. The preferred embodiments use multispectral excitation to enhance accuracy and sensitivity (i.e. to enhance true positives and suppress false positive identifications).

In accordance with one embodiment of the invention, the detection of emission photons is accomplished with a receiver that includes optics, a spectrograph, and a detector array. The system can further include an analysis system that identifies particular substances of interest, such as explosives, illegal drugs (and accompanying by-products), dangerous chemicals, and bio-aerosols harmful to humans. In one embodiment, the invention preferably operates within the ultraviolet radiation wavelength range of approximately 240 nanometers to approximately 540 nanometers (though other wavelength ranges can also be used).

Multispectral excitation and/or detection is accomplished with the invention in a number of ways. Selection and control of either excitation wavelengths or detection wavelengths can be accomplished using, among other things, a pulsed power sources (e.g. a sequence-pulsed laser system) in conjunction with data collection corresponding to each pulse, a spectral filter wheel(s) to select or vary different excitation or detection wavelengths and combinations thereof. The sensitivity of the invention can be further enhanced by use of a shutter system as described in the figures below. Use of shutters minimizes extraneous light sources by selectively limiting access of extraneous light (as well as excitation and emission light) to the detector. For example, a shutter may be triggered to open within a discreet period of time in conjunction with an excitation pulse in order to limit the interference effects of extraneous light sources.

Regardless of the particular configuration, the sensitivity limits of the system may depend on any of several factors. These factors include: energy source availability, cross-section of photoelectric absorption, path length, detector collecting area, detector spectral resolution, detector geometrical characteristics, integration time, and detector noise limit. A number of steps have been taken to minimize the negative effects of these factors.

In another embodiment of the invention, the detection system uses a continuous output deuterium ultraviolet source with narrow-band interference filter(s) and/or monochromator to define the excitation spectral properties. In such an arrangement, the power density available at full output power is 1 mW/cm². The UV output is collected by a 3 cm² area lens and directed at the target area. The lens produces a concentrated illumination spot (˜100 mm diameter) on a target at an approximately 300 mm standoff.

In this embodiment, the cross-section of the target is optimized for photoelectric absorption by selecting a fixed spectral filter or by using a monochromator to provide the required excitation wavelength for each substance of interest in the target area. Simultaneously, a receiver comprising a spectrograph and ultraviolet-sensitive detector views the target area. Thereafter, quick emission samples (or exposures) are recorded and the resultant spectra compared to a database of known substances. Using this system, sensitivities of 100 parts per million (ppm) have been achieved in a 4 inch diameter area at a standoff distance of 12 inches.

The invention also provides the ability to detect and analyze substances within target areas at substantial standoff distances whether in liquid, solid, or gaseous form. The invention is amenable to unique system configurations (including critical component placement) as well as creation and maintenance of a database of unique signatures for individual and complex mixtures of substances. The invention can utilize miniature spectrograph instruments coupled to detector arrays with high efficiency power capabilities and novel source optics design. The invention's hardware can implement various incident power stabilization methodologies and improved analyses including sample evaluations based on pulsed timing sequences as well as pulse-synchronization modes for operation in sunlight and room light environments

Modifications and variations of the present invention are possible and envisioned in light of the above descriptions. It is therefore to be understood that within the scope of the attached detailed description, examples and claims, the invention may be practiced otherwise than as specifically described.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates a functional block diagram of a long distance UV absorption detection system in accordance with an embodiment of the invention;

FIG. 2 illustrates a functional block diagram of a portable UV absorption detection system in accordance with an embodiment of the invention;

FIG. 3 illustrates a functional block diagram of a hand-held and/or portable UV absorption detection system in accordance with an embodiment of the invention;

FIG. 4 is a flow chart illustrating a process for matching measured fluorescence data with known signature spectra of certain compounds in accordance with an embodiment of the invention;

FIG. 5 illustrates a UV Spectrum of C4 Explosive as determined with a UV absorption detection system in accordance with an embodiment of the invention;

FIG. 6 illustrates a UV Spectrum of Cocaine as determined with a UV absorption detection system in accordance with an embodiment of the invention;

FIG. 7 illustrates a UV Spectrum of TATP Explosive as determined with a UV absorption detection system in accordance with an embodiment of the invention; and

FIG. 8 illustrates a UV Spectrum of TNT Explosive (U.S.) as determined with a UV absorption detection system in accordance with an embodiment of the invention.

### DETAILED DESCRIPTION OF THE PREFERRED EMBODIMENTS

Reference will now be made in detail to the preferred embodiments of the invention. This invention may, however, be embodied in many different forms and should not be construed as limited to the embodiments set forth herein. In addition and as will be appreciated by one of skill in the art, the invention may be embodied as a product, method, system or process.

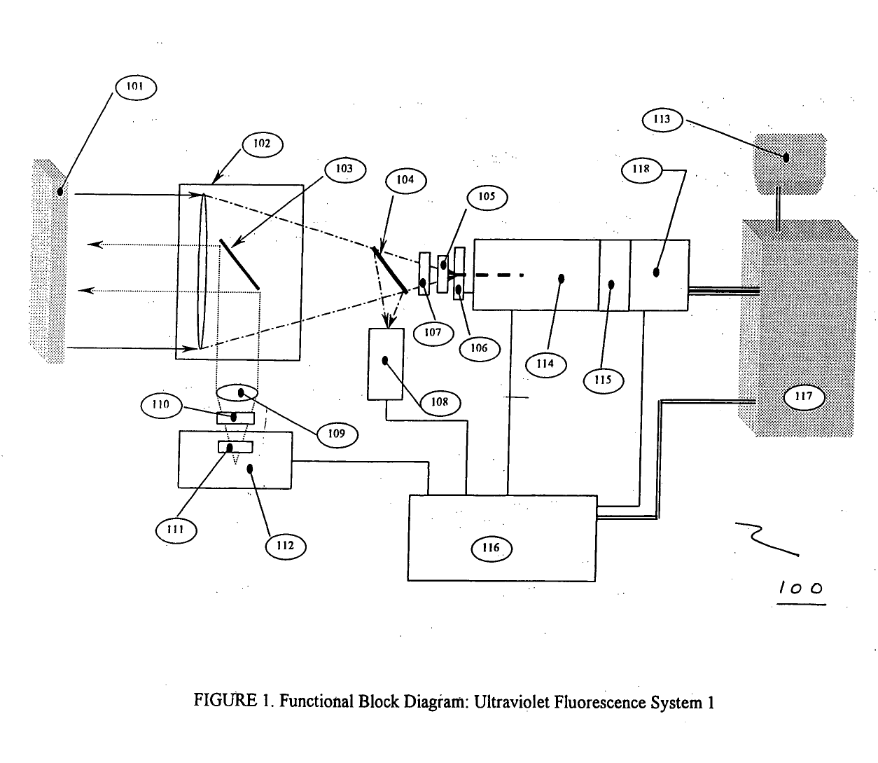

FIG. 1 illustrates a functional block diagram of a long distance UV absorption detection system 100 in accordance with an embodiment of the invention suitable for detecting substances at standoff distances from a few centimeters to several kilometers. FIG. 1 shows the UV fluorescence detection system 100 configured for detection of controlled and other dangerous substances whose residues are either on the surfaces of containers, suitcases, shoes, and removable clothing or in vapor form in the surrounding air. The system is preferably contained in a light-tight enclosure to minimize interference from unwanted extraneous light sources during the measurement and detection process.

In FIG. 1, excitation light is generated by a source 112. The source 112 can include, among other things, a tunable laser, a flash lamp of suitable intensity, a UV LED or a solid-state UV laser diode. The excitation light may have a wide range of wavelengths and is preferable in the range of about 240 nm to 540 nm. Excitation light from the light source 112 is then passed through a spectral filter 111 (which optionally can include, among other things, a filter wheel for excitation wavelength selection), a shutter 110, and an optical lens 109. Next, the light is reflected by a mirror 103 toward a target area 101 (which contains the sample and species under examination). If the sample in the target area 101 photoelectrically responds to the incident excitation light (i.e. it fluoresces), the fluorescence manifests itself as a light flux within a specific band of the UV spectrum of wavelengths. Thus, the source 112, the filter 111, the shutter 110 and the optical lens 109 serve to illuminate and excite the target area 101 that may include the substance to be identified.

The UV absorption detection system 100 gathers fluorescent emissions from the sample located at the target area 101 through an input optic(s) 102. Input optic 102 can be, but is not limited to, a lightweight reflective optic(s) or an appropriate refractive (lens) optic(s). The input optic 102 in accordance with the invention can be of differing sizes depending on the desired configuration. For example, in order to detect substances at large distances, the input optic may be very large, for example 1.4 meters in diameter. On the other hand, for the input optic 102 may be significantly smaller as described below in connection with a portable detection system. After passing through the input optics 102, a dichroic beam splitter 104 splits the emitted light into a visible light component and a UV light component. The visible light component can optionally be directed to a camera 108 for visual target inspection and target aiming while the UV light component is directed to and through a spectrograph shutter 107, a spectral filter 105 (which optionally can include, among other things, a filter wheel for detection wavelength selection) and an input slit 106. It should be noted that shutters 110 and 107 can each be coordinated to selectively open and close to minimize interference and scatter effects from, among other things, extraneous light and dust. For example, shutters 110 and 107 can each be triggered to open within a discreet period of time in conjunction with an excitation pulse in order to limit the interference effects of extraneous light sources. Light passing through the input slit 106 enters a spectrograph 114 that is optically matched to the UV light beam.

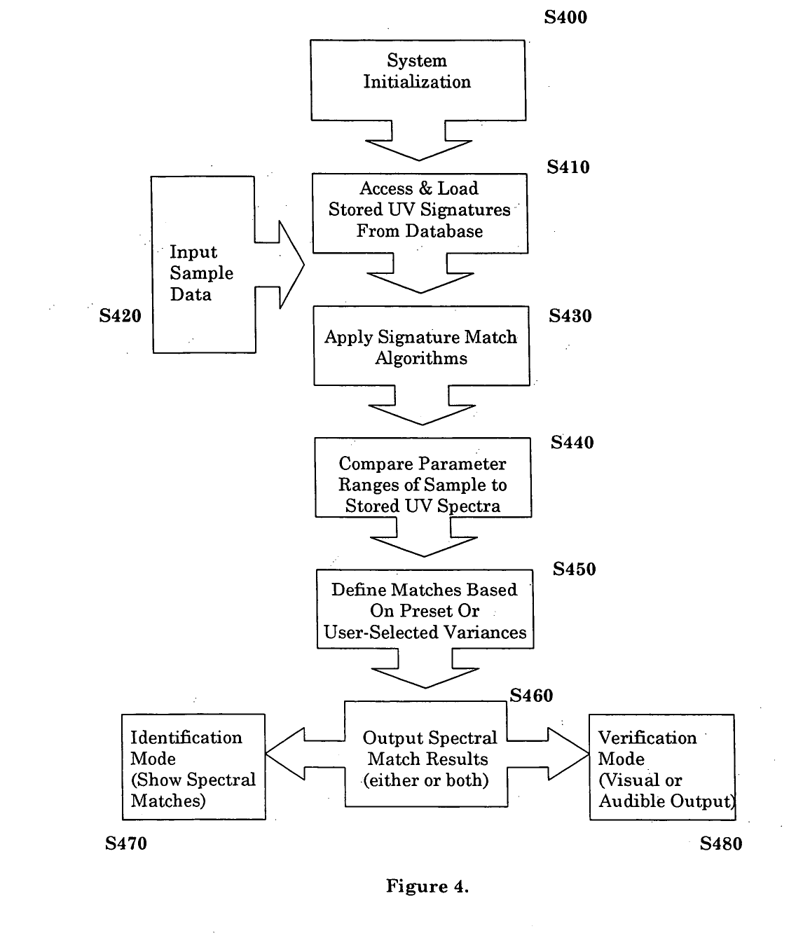

An internal grating (not shown) inside the spectrograph 114 provides spectral separation, which involves separation of the input spectrum into its individual wavelength components. Internal optics (not shown) within the spectrograph 114 then reimage the separated input spectrum onto a CCD linear array detector 115, which may optionally be cooled. The CCD detector 115 converts the UV light components into electrical signals that are then processed by a signal processor 118 and analyzed using an attached computer 117. As will be described in greater detail below in connection with FIG. 4, the computer 117 includes an analysis system that provides for a variety of output data based on comparisons of material(s) detected within target area 101 and a database of known materials. Thus, the computer 117 executes a matching operation whereby output signals from the CCD are matched against know signature spectra of certain chemical compounds.

The data and analysis from the computer 117 are presented to a display device 113 that can include a computer monitor or a set of lights indicating the presence or absence of certain substances. A power source 116 supplies power to the various components of the UV detection system 100. The power source 116 can include, among other things, an AC main supply, batteries or similarly suitable power supplies.

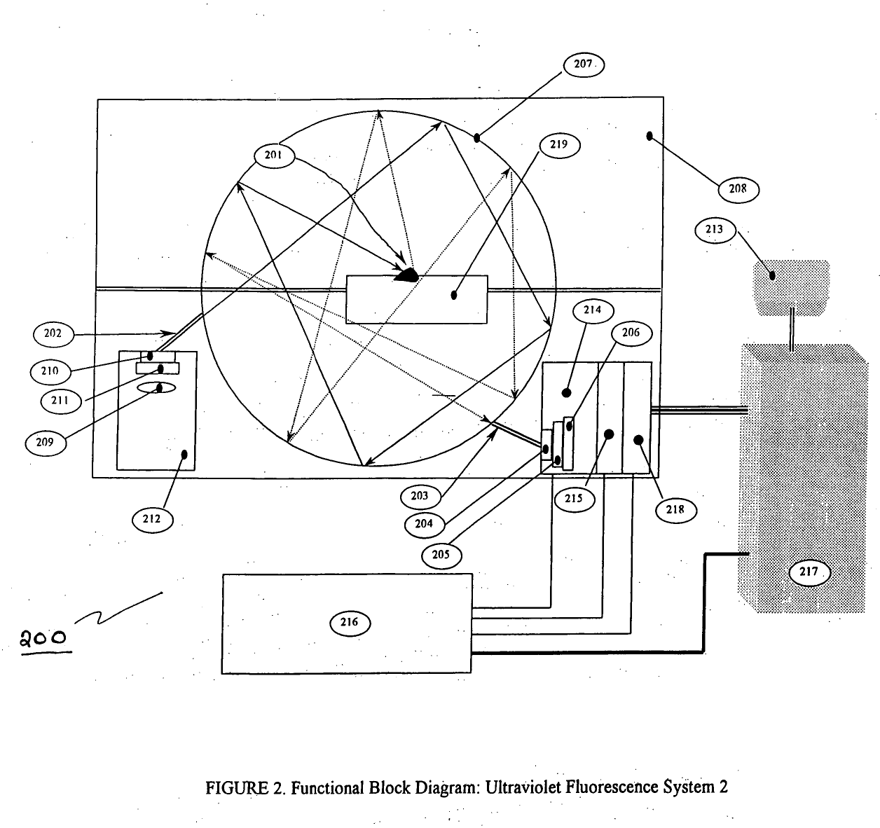

FIG. 2 illustrates a functional block diagram of a portable UV absorption detection system 200 in accordance with an embodiment of the invention suitable for detecting substances inside a closed container, such as might be used at security stations checking shoes, briefcases, and the like. FIG. 2 shows the UV fluorescence detection system 200 configured for detection of controlled and other dangerous substances whose residues are either on the surfaces of objects or inside an object that transmits UV light.

In FIG. 2, the UV detection system 200 preferably resides in a lighttight enclosure 208 to minimize extraneous unwanted light during the measurement and detection process. Excitation light is generated by a source, 212, which can include, among other things, a tunable laser, a flash lamp of suitable intensity, a UV LED or a solid-state UV laser diode. Light from the light source 212 is then passed through an optical lens 209 and a spectral filter 211 (which optionally can include, among other things, a filter wheel for excitation wavelength selection) from which it directed onto a fiber optic coupler 210 that passes it along to an optical fiber 202. Optical fiber 202 directs the light to the interior of a reflective spherical surface 207.

The reflective spherical surface 207 is contained within an enclosure 208. Enclosure 208 separates to reveal two hemispherical parts to facilitate placement of the object that may contain a sample to be analyzed 201 located on or within the target object or area 219. The excitation light is repeatedly reflected within the reflective spherical surface 207 until it impinges upon sample 201 (if present). If the sample 201 photoelectrically responds to the incident excitation light (i.e. it fluoresces), the fluorescence manifests itself as a light flux within a specific band of the UV spectrum of wavelengths.

If fluorescence occurs, the UV emission (as a component of the total light transmitted through the unit) is successively gathered by an input optical fiber 203 after a number of reflections off the walls of reflective spherical surface 207. The collected light passes along the optical fiber 203, through a fiber optic coupler 204, a spectral filter 205 (which optionally can include, among other things, a filter wheel for detection wavelength selection) into an input slit 206. Light passing through the input slit 206 enters a spectrograph 214 that is optically matched to the UV light beam.

An internal grating (not shown) inside the spectrograph 214 provides spectral separation, which involves separation of the input spectrum into its individual wavelength components. Internal optics (not shown) within the spectrograph 214 then reimage the separated input spectrum onto a CCD linear array detector 215, which may optionally be cooled. The CCD detector 215 converts the UV light components into electrical signals that are then processed by a signal processor 218 and analyzed using an analysis system in conjunction with an attached computer 217. As will be described in greater detail below in connection with FIG. 4, the computer 217 includes an analysis system that provides for a variety of output data based on comparisons of material(s) detected within target area 201 and a database of known materials. Thus, the computer 217 executes a matching operation whereby output signals from the CCD are matched against know signature spectra of certain chemical compounds.

The data and analysis are presented to a display device 213 that can include a computer monitor or a set of lights indicating the presence or absence of certain substances. A power source 216 supplies power to the various components of the UV detection system 200. The power source 216 can include, among other things, an AC main supply, batteries or similarly suitable power supplies.

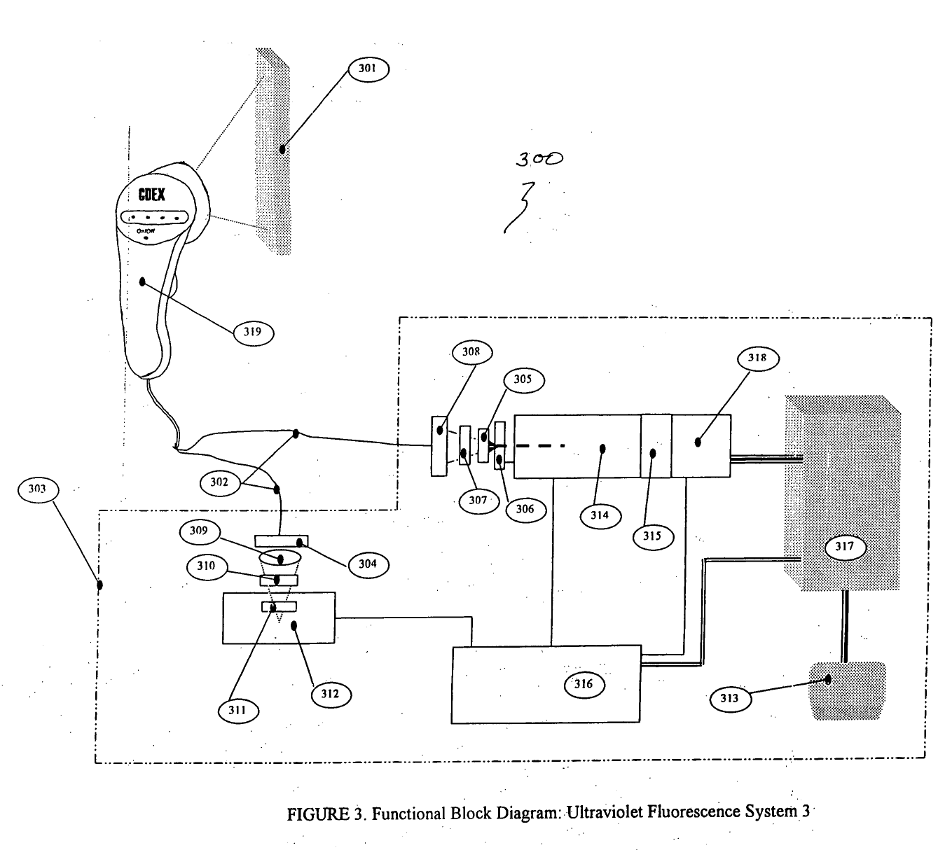

FIG. 3 illustrates a functional block diagram of a hand-held and/or portable UV absorption detection system 300 in accordance with an embodiment of the invention suitable for detecting substances on objects or personnel at relatively close distances, such as those utilized for screening of airline passengers and other scenarios requiring a hand-held scanner. FIG. 3 shows a UV detection system 300 configured for detection of controlled and other dangerous substances whose residues are on the surfaces of personnel, containers, suitcases, shoes, clothing, and the like. Of particular importance, the embodiment of FIG. 3 does not need be contained in a light-tight enclosure because it employs several means to minimize the effects of unwanted extraneous light.

In FIG. 3, excitation light is generated by a source 312. The source 312 can include, among other things, a tunable laser, a flash lamp of suitable intensity, a UV LED or a solid-state UV laser diode. Light from the source 312 is then passed through a spectral filter 311(which optionally can include, among other things, a filter wheel for excitation wavelength selection), a shutter 310 and an optical lens 309 from which it is directed onto a fiber optic coupler 304. The fiber optic coupler 304 passes the excitation light along optical fiber cables 302 to handheld scanner 319. The handheld scanner 319 can then be used to direct the excitation light toward the target area 301 (that may contain the species under examination). If the sample in the target area 301 photoelectrically responds to the incident excitation light (i.e. it fluoresces), the fluorescence manifests itself as a light flux within a specific band of the UV spectrum of wavelengths. Thus, the source 312, the filter 311, the shutter 310, the optical lens 309, the fiber optic coupler 304, the fiber optic cables 302 and the handheld scanner 319 serve to illuminate and excite the target area 301 that may include the substance to be identified.

If fluorescence occurs, the UV emission (as a component of the total light detected by the unit) is gathered through an input optic input fiber optic(s) 302 located within handheld scanner 319. As depicted in FIG. 3, the input fiber optic(s) 302 corresponds with optical fibers 302 discussed above, though they can also be separate optic materials. The collected light passes along the input fiber optic(s) 302, through a fiber optic coupler 308, a shutter 307, a spectral filter 305 (which optionally can include, among other things, a filter wheel for detection wavelength selection) and onto an input slit 306. It should be noted that shutters 110 and 107 can each be coordinated to selectively open and close to minimize interference and scatter effects from, among other things, extraneous light and dust. For example, shutters 310 and 307 can each be triggered to open within a discreet period of time in conjunction with an excitation pulse in order to limit the interference effects of extraneous light sources. Light passing through the input slit 306 enters a spectrograph 314 that is optically matched to the UV light beam.

An internal grating (not shown) inside the spectrograph 314 provides spectral separation, which involves separation of the input spectrum into its individual wavelength components. Internal optics (not shown) within the spectrograph 314 then reimage the separated input spectrum onto a CCD linear array detector 315, which may optionally be cooled. The CCD detector 315 converts the UV light components into electrical signals that are then processed by a signal processor 318 and analyzed using an analysis system in conjunction with an attached computer 317. As will be described in greater detail below in connection with FIG. 4, the computer 317 includes an analysis system that provides for a variety of output data based on comparisons of material(s) detected within target area 301 and a database of known materials. Thus, the computer 317 executes a matching operation whereby output signals from the CCD are matched against know signature spectra of certain chemical compounds.

The data and analysis are presented to a display device 313 that can include a computer monitor or a set of lights indicating the presence or absence of certain substances. A power source 316 supplies power to the various components of the UV detection system 300. The power source 316 can include, among other things, an AC main supply, batteries or similarly suitable power supplies.

In FIG. 1-3, an analysis system (as well as instrumentation calibration) plays an important role in operational efficiency. A computer running the UV absorption detection systems functions as a controller unit for the detection system and provides the capability to customize all the various parameters for different applications.

Accumulated data can be displayed on a computer with a standard computer screen and/or a customized display module. A standard computer screen display can serve as the initial interface for assessment and/or manipulation of resultant spectral as well as allow for interactive adjustment of preset system parameters. Such determinations include, but are not limited to, identifying the presence, or lack thereof, of certain materials and substances.

A customized display module can also be utilized with any configuration of the invention including the embodiments illustrated in FIGS. 1-3. A customized display module can include devices capable of indicating sampling and detection results through the use of illuminated LED's. For example, a customized display module can be designed to indicate a number of messages including, but not limited to: “Clear” (if no substances of interest are present), “Substance Found” (if one or more of the pre-selected substance types are identified), “Re-measure” (if the analysis system was uncertain in determining the presence of the substance(s)), “Fault”,(if a monitored system parameter is not functioning properly), “Ready” (if the system is ready to acquire another data point) and/or “Acquiring” (if the system is in the process of acquiring another set of data points).

The invention also allows for the evaluation of the data generated by the UV absorption detection system. Among other things, the invention can determine the presence, absence (and distinguish between) a variety of materials, including, but not limited to explosive materials, narcotics, and commercial drugs. The system in accordance with the invention enables for visual and/or audible output on accompanying hardware based on preset detection criteria. Additionally, the system can be enabled to contemplate and anticipate evolving “what-if” scenarios by retrieving and evaluating previous data under different selected test conditions or test parameters.

Configured for use in a UV absorption detection system in accordance with an embodiment of the invention, the system can, among other things, repeatedly analyze sample data (in the form of a UV spectrum) on a continuous basis after each fluorescence scan cycle to determine the presence of a chemical substance (e.g. explosives, drugs etc.). Determination of the presence (or absence) of a substance(s) is based on algorithmic-based comparisons of the evolving sample spectrum and the unique spectral signatures of known materials (which comprise a system-accessible database).

In accordance with an embodiment of the invention, the unique spectral signatures are assigned name and type strings (thus allowing easy discreet comparisons of each signature). Each signature can also be assigned a base point for use as a reference point along with a variable number of other points defining its characteristic spectrum.

Signatures for known compounds are stored in a plain text files for ease of adding new, or modifying existing signatures. As stored, the individual UV spectra of the compounds comprise an array of counts recorded in an ordered set of channels (i.e. the UV spectrum of an individual compound is a series of numbers). During initialization, the system loads the stored plain-text sample signatures into an array. The elements of the array are then compared against the evolving spectrum as it is being acquired.

Signature matching can be accomplished using, among other things, a 20th order power series of cosine functions for curve-matching that is rapid, and allows for flexibility. Each channel for a known UV spectrum corresponds to a partial wavelength range of the UV emission wavelengths able to be recorded in the detector. Whenever UV light of a specific frequency enters the spectrometer, it enters a corresponding channel, causing the counter for that channel to be incremented. When a scan is complete, the incremented counts for all the channels are returned as an integer array.

Once the input data is accumulated in the integer array, it is matched with a signature in a spectrum using a least-square curve-fitting routine that reduces the measured spectrum to a small set of digital numbers sufficient to describe the key information contained in the spectrum. The best fit of this curve may use up to a 24th-order equation.

The signature-matching algorithm begins by comparing the description parameters stored in the database. Each parameter is checked in sequence to see if the parameter's value is within a range corresponding to a defined UV spectrum in the database. An appropriate range can be defined as three standard deviations above and below the average channel value. Comparisons can also be made using an average channel value and/or standard deviation value for each target material contained in the database.

When all the database signatures are checked, signature(s) that fall within the defined range are classified as a match. When more than one signature material qualifies as a match, the system allows for comparison of the various possible matches with the sample material (including, among other things, overlays of the spectrum). The system also enables an IDENTIFICATION mode in which the names of all the matched materials are displayed for the users consideration. The system also enables a VERIFICATION mode in which either or both visual and audible indications are returned for the positive and/or negative sample matches.

FIG. 4 is a flow chart illustrating a process for matching measured fluorescence data with known signature spectra of certain compounds in accordance with an embodiment of the invention. In FIG. 4, the matching process begins at step S400 wherein the system is initialized. The process then moves to step S410 in which the system accesses and loads UV signatures from known materials that are stored on a system-accessible database. The process then moves to step S420 where the data from an evolving sample spectrum being acquired is supplied to the system. For example, this step may include receiving processed signals from a CCD and/or signal processor as shown in FIG. 1. In step S430 the system applies algorithms to the acquired sample data provided in step S420. This step can include, for example, application of a 20th order power series of cosine functions for curve matching. Next, in step S440, the manipulated sample data from steps S420 and S430 is compared to the UV signatures loaded from the database in step S410. Step S440 can include, for example, using a least-square curve-fitting routine that reduces the measured spectrum to a small set of digital numbers sufficient to describe the key information contained in the spectrum, including using up to a 24th-order equation. In step S450, the system determines whether there has been a match based on the comparison procedure in step S440. A match can defined as a preset standard deviation between values from the sample spectrum and those of stored spectra, such as, for example, three standard deviations above or below a average value of a stored spectrum). Next, in step S460, the system outputs the results of any matches. Step S460 can include either (or both) of steps S470 (in which the system provides spectral results for visual inspection by the operator and/or provides overlays of the produced spectra) and step S480 (in which visual and/or audible alarms indicate a match).

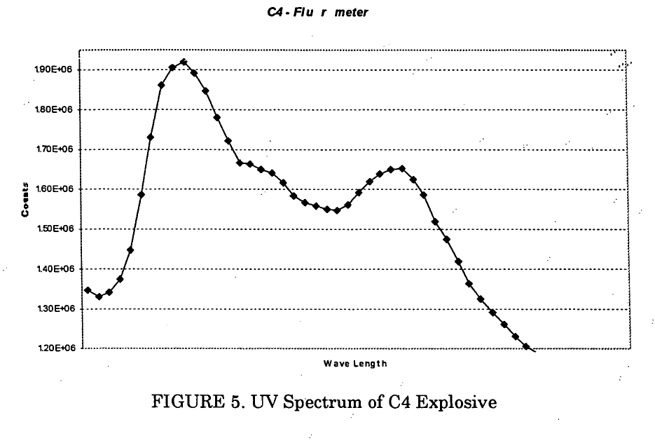

Specific embodiments of the generalized UV absorption detection systems illustrated in FIGS. 1-3 have been used to obtain fluorescence spectra for a number of materials including TNT (US), TNT (Russia), RDX, PETN, C4, Cocaine, Heroin and 27 commercial drugs. FIGS. 5-8 are representative of such spectra and are for illustrative purposes only and are not intended nor should they be interpreted to limit the scope of the application.

FIG. 5 illustrates the UV Spectrum of C4 Explosive as determined with a UV absorption detection system in accordance with an embodiment of the invention.

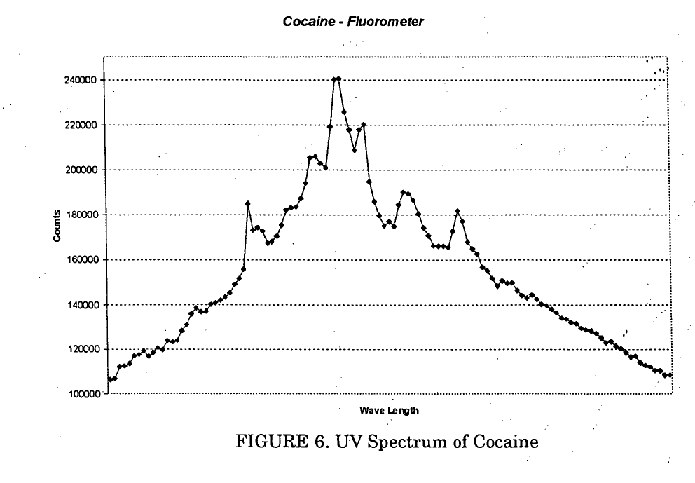

FIG. 6 illustrates the UV Spectrum of Cocaine as determined with a UV absorption detection system in accordance with an embodiment of the invention.

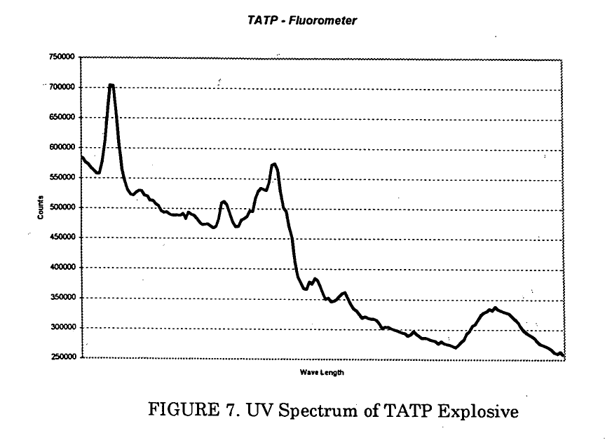

FIG. 7 illustrates the UV Spectrum of TATP Explosive as determined with a UV absorption detection system in accordance with an embodiment of the invention.

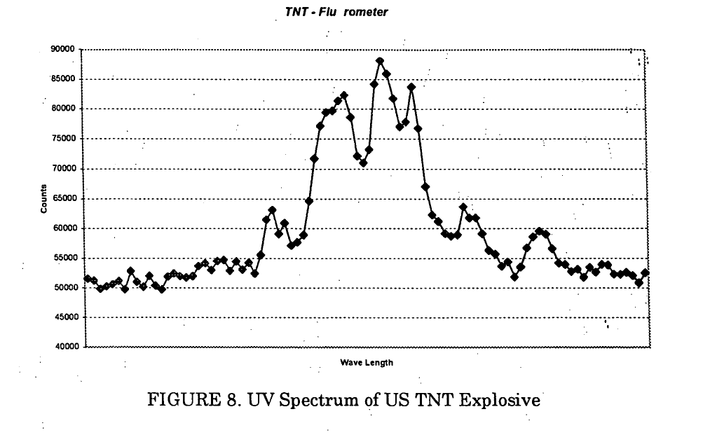

FIG. 8 illustrates the UV Spectrum of TNT Explosive (U.S.) as determined with a UV absorption detection system in accordance with an embodiment of the invention.

The invention can be configured in a variety of different ways including, but not limited to, a large distance standoff embodiment, a handheld scanner embodiment as well as vehicle/mobile mounted embodiments and fixed-mounted embodiments. In particular, the disclosed embodiments include a low-power system of high reliability that is capable of operating at large, safe standoff distances from suspected dangerous materials without the disadvantages of a large energy source, predictive analysis system or high power consumption. For relatively short distances (e.g. 1-10 cm), laser diodes or LEDs of sufficient power output can be effectively utilized as power sources. For longer distances (up to several kilometers), a tunable pulsed laser with an appropriate beam expander can be used as the source of UV photons to excite materials of interest. Unattended operation is possible and rapid response time provides identification of suspect substances more quickly than other approaches. Likewise, the disclosed embodiments include a small hand-held system that provides convenient, highly accurate sample detection with very low energy demands.

Based on experimental data, an embodiment of the invention has an effective signal to noise detection ration of 100:1 (or greater) for common explosive materials at 0.5-meter standoff distances. This level of sensitivity indicates that an operational, commercial embodiment of the invention would be effective at approximately 5-meter detection distances (assuming similar integration times, instrument settings and environmental parameters). In particular, testing indicates a first-order spectral resolution of 0.1 nm between 240-540 nm for one embodiment using a 1024-element CCD sensor. This level of resolution translates into an approximately 35% optical efficiency.

It is further envisioned that use of higher source power and/or larger collecting optics would increase the operational range (e.g. up to approximately 2.2 kilometers using a 1.4 meter diameter F/2 collecting optic (e.g. mirror) and a 250 millijoule laser source) while maintaining sensitivity and accuracy. As improved components become available, these ranges may be extended and/or sample detection and analysis times may be reduced.

The invention has an extensive number of applications. A non-exclusive list includes, but is not limited to: any industries, processes and/or equipment requiring remote, non-invasive sensing of multiple chemical compounds or constituents (such as in the chemical, petroleum and other similar industries, internal pollution and contamination controls, external pollution and contamination controls, illegal drug detection and monitoring, commercial drug quality control and dispensing verification, nuclear waste and effluent monitoring, air standards determination, explosives monitoring and detection, semiconductor industry effluent monitoring and control, hazardous waste and emission monitoring, semiconductor quality control measures, semiconductor processing contamination monitoring and control, plasma monitoring and control, waste dump site monitoring and control, nuclear, biological, and chemical weapons by-products monitoring, clean room monitoring and control, clean room tools monitoring, vacuum controls, laminar flow controls and controlled environments); security monitoring (including airport and transportation security, improvised explosive device (IED) detection, military and civilian ship and building security, drug (illegal and commercial) security, explosives, weapons and bio-hazard manufacture, detection and storage); remediation (including of hazardous and toxic materials, chemicals, buried land mines, unexploded ordinance, and other explosive devices).

It will be apparent to those skilled in the art that various modifications and variations can be made in the present invention and specific examples provided herein without departing from the spirit or scope of the invention. Thus, it is intended that the present invention covers the modifications and variations of this invention that come within the scope of any claims and their equivalents.

what is claimed is:

1. An ultraviolet fluorescence detector comprising:
an excitation light source;
a sample receiving platform capable of receiving excitation light from said excitation light source;
an ultraviolet light detector for receiving induced fluorescent energy;
an analysis module for matching said induced fluorescent ultraviolet energy against a previously determined signature spectrum.

2. The ultraviolet fluorescence detector of claim 1, further comprising a camera platform.

3. The ultraviolet fluorescence detector of claim 1, further comprising a first optics for directing said excitation light to said sample receiving platform.

4. The ultraviolet fluorescence detector of claim 3, wherein said first optics includes at least one of an optical lens, a shutter, a filter, a mirror, a fiber optic coupler and an optical fiber.

5. The ultraviolet fluorescence detector of claim 4, wherein said filter is a filter wheel.

6. The ultraviolet fluorescence detector of claim 1, further comprising an input optic for passing the induced fluorescent energy to said ultraviolet light detector.

7. The ultraviolet fluorescence detector of claim 6, wherein the input optic is an F/2 lens having a diameter over approximately 1.0 meters.

8. The ultraviolet fluorescence detector of claim 1, further comprising a second optic for receiving said induced fluorescent energy.

9. The ultraviolet fluorescence detector of claim 8, wherein said second optic includes at least one of a mirror, a lens, a beam splitter, a shutter, a fiber optic fiber, a fiber optic coupler, a filter and an input slit.

10. The ultraviolet fluorescence detector of claim 6, wherein said filter is a filter wheel.

11. The ultraviolet fluorescence detector of claim 1, wherein said ultraviolet light detector includes a spectrograph.

12. The ultraviolet fluorescence detector of claim 1, further comprising a CCD detector.

13. The ultraviolet fluorescence detector of claim 10, wherein said CCD detector is cooled.

14. The ultraviolet fluorescence detector of claim 1, wherein said analysis module includes a computer.

15. The ultraviolet fluorescence detector of claim 1, further comprising a signal processor.

16. The ultraviolet fluorescence detector of claim 1, further comprising at least one power source providing power to said excitation light source, said sample receiving platform, said ultraviolet light detector and said detection module.

17. The ultraviolet fluorescence detector of claim 1, wherein said excitation light source includes at least one of a tunable laser, a flash lamp, an ultraviolet LED and a solid state ultraviolet diode.

18. The ultraviolet fluorescence detector of claim 1, wherein said excitation light source includes a laser source of approximately 0.1 to approximately 250 millijoules.

19. The ultraviolet fluorescence detector of claim 1, wherein the excitation light source is a pulsed light source.

20. The ultraviolet fluorescence detector of claim 1, further comprising a controller that monitors said excitation light source for the purpose of detected substance spectrum stabilization.

21. The ultraviolet fluorescence detector of claim 1, wherein ultraviolet fluorescence detector detects ultraviolet signals between approximately 240 nanometers and approximately 540 nanometers.

22. The ultraviolet fluorescence detector of claim 1, further comprising a light minimizing enclosure.

23. The ultraviolet fluorescence detector of claim 22, wherein said light minimizing includes a reflective spherical surface.

24. The ultraviolet fluorescence detector of claim 1, further comprising a handheld scanner.

25. The ultraviolet fluorescence detector of claim 24, wherein said hand held scanner connect to said ultraviolet fluorescence detector via fiber optic materials.

26. The ultraviolet fluorescence detector of claim 1, wherein said ultraviolet fluorescence detector can detect ultraviolet emissions from a chemical compound.

27. The ultraviolet fluorescence detector of claim 23, wherein said chemical compound includes at least one of a drug, an explosive, a biological agent, a biochemical agent, a nuclear material, a narcotic material, a petroleum material and a waste material.

28. A method for detecting and analyzing chemical substances using ultraviolet fluorescence comprising the steps of:
directing an excitation light source to a target material;
receiving induced fluorescent energy from said target material; and
determining the nature of the target material based upon the received induced fluorescent energy.

29. The method of claim 28, wherein the said step of directing includes directing excitation light through first optics that include at least one of an optical lens, a shutter, a filter, a mirror, a fiber optic coupler and an optical fiber.

30. The method of claim 29, wherein the received induced fluorescent energy has passed through an optic having an F/2 mirror and is at least approximately 1.0 meters in diameter.

31. The method of claim 28, wherein the said step of determining includes comparing parameter ranges for said received induced fluorescent energy with predetermined ultraviolet parameters and defining a match based on a predetermined standard deviation between said received induced fluorescent energy and predetermined ultraviolet parameters.
